(19) United States
(12) Patent Application Publication
(10) Pub. No.: US 2019/0283548 A1
(43) Pub. Date: Sep. 19, 2019

(54) HUMIDIFYING DEVICE

(71) Applicant: DENSO CORPORATION, Kariya-city (JP)

(72) Inventors: Miyuki SAITO, Kariya-city (JP); Manabu MAEDA, Kariya-city (JP); Hitoshi NINOMIYA, Kariya-city (JP); Yusuke KOMATSUBARA, Kariya-city (JP); Daichi TSUBOKURA, Kariya-city (JP)

(21) Appl. No.: 16/432,126

(22) Filed: Jun. 5, 2019

Related U.S. Application Data
(63) Continuation of application No. PCT/JP2017/037036, filed on Oct. 12, 2017.

(30) Foreign Application Priority Data
Dec. 21, 2016 (JP) 2016-248184

(51) Int. Cl. B60H 3/02; B01D 53/04; F24F 3/14; B60H 1/03

(52) U.S. Cl. CPC B60H 3/02; B01D 53/04; F24F 6/04; B60H 1/03; B60H 2003/026; F24F 3/1411

(57) ABSTRACT

A humidifying device includes a casing that defines a first air passage that guides air to an adsorbent module accommodation portion accommodating an adsorbent module including an adsorbent, and a second air passage through which the air flowing out of the adsorbent module accommodation portion flows. The humidifying device includes a peltier device that has a heat absorbing side and a heat generating side generating heat due to heat transfer from the heat absorbing side. The peltier device is housed in the casing such that the heat generating side is located in the first air passage and the heat absorbing side is located in the second air passage.

### CROSS REFERENCE TO RELATED APPLICATIONS

The present application is a continuation application of International Patent Application No. PCT/JP2017/037036 filed on Oct. 12, 2017, which designated the United States and claims the benefit of priority from Japanese Patent Application No. 2016-248184 filed on Dec. 21, 2016. The entire disclosures of all of the above applications are incorporated herein by reference.

### TECHNICAL FIELD

The present disclosure relates to a humidifying device.

### BACKGROUND

A general humidifying device includes a heater that is a heating device, an adsorbent module that releases moisture adsorbed to an adsorbent to the air heated by the heater, and a cooling device that cools the air flowing through the adsorbent module.

### SUMMARY

A humidifying device according to an aspect of the present disclosure includes: a casing that defines a first air passage that guides air to an adsorbent module accommodation portion accommodating an adsorbent module including an adsorbent, and a second air passage through which the air flowing out of the adsorbent module accommodation portion flows; and a peltier device that has a heat absorbing side absorbing heat according to an electric current flowing in a junction of different metals, and a heat generating side generating heat due to heat transfer from the heat absorbing side. The peltier device is housed in the casing such that the heat generating side is located in the first air passage and the heat absorbing side is located in the second air passage.

### BRIEF DESCRIPTION OF THE DRAWINGS

FIG. 1 is a diagram showing a configuration of a humidifying device according to at least one embodiment.

FIG. 2 is a block diagram of the humidifying device according to at least one embodiment.

FIG. 3 is a diagram for explaining an air flow when moisture in air is adsorbed to an adsorbent.

FIG. 4 is a diagram showing a configuration of a humidifying device according to at least one embodiment.

FIG. 5 is a diagram showing a configuration of a humidifying device according to at least one embodiment.

FIG. 6 is a diagram showing a configuration of a humidifying device according to at least one embodiment.

FIG. 7 is a diagram showing a configuration of a humidifying device according to at least one embodiment.

FIG. 8 is a diagram showing a configuration of a humidifying device according to at least one embodiment.

FIG. 9 is a diagram showing a configuration of a humidifying device according to at least one embodiment.

FIG. 10 is a diagram showing a configuration of a humidifying device according to at least one embodiment.

### EMBODIMENTS

Hereinafter, embodiments will be described with reference to the drawings. In the respective embodiments described herein, identical or equivalent parts are given identical reference numerals in the figures.

### First Embodiment

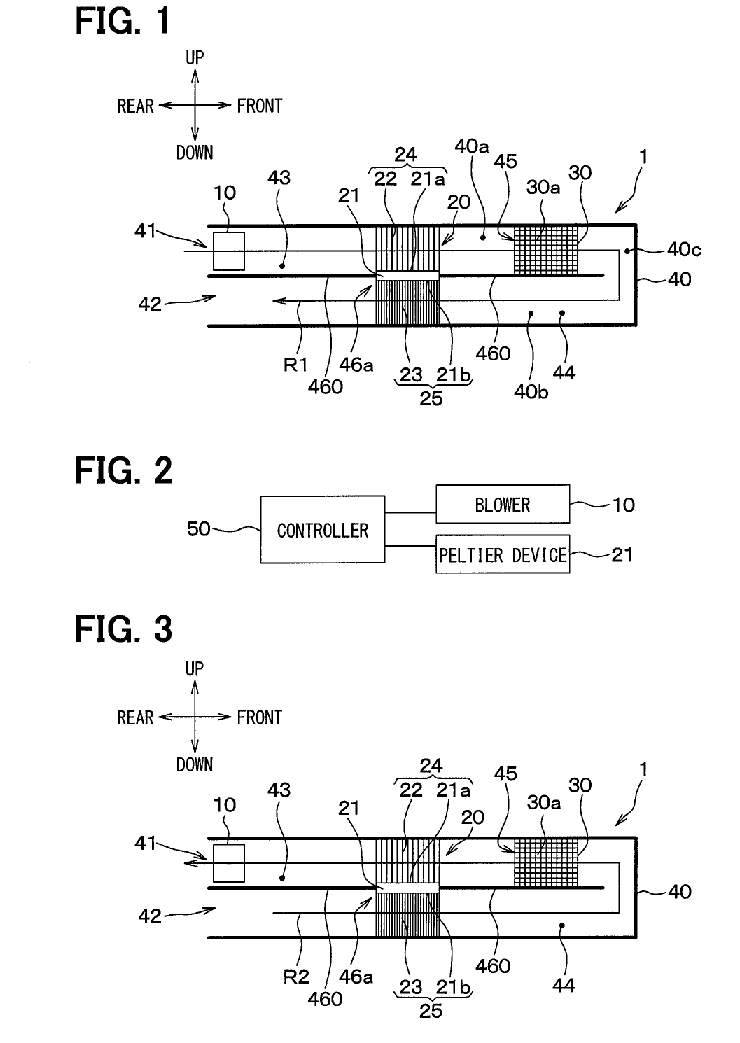

A humidifying device 1 according to a first embodiment will be described with reference to FIGS. 1 through 3. FIG. 1 is a diagram illustrating a humidifying device 1 of the present embodiment. FIG. 2 is a block diagram of the humidifying device 1 of the present embodiment. FIG. 3 is a diagram for explaining an air flow when moisture in air is adsorbed to the adsorbent 30a. Arrows shown in the drawings indicating up-down, front-rear, left-right directions represent directions of a humidifying device 1 mounted on a vehicle. The humidifying device 1 humidifies air and supplies the humidified air to a humidification target space. The humidifying device 1 of the present embodiment is located inside a passenger compartment of a vehicle and humidifies the passenger compartment as the humidification target space.

The humidifying device 1 includes a blower 10, a peltier device 21, an adsorbent module 30, and a casing 40. The blower 10, the peltier device 21, and the adsorbent module 30 are accommodated in the casing 40.

The casing 40 includes a first opening 41, a second opening 42, a first air passage 43, a second air passage 44, an adsorbent module accommodation portion 45, and a partition wall 460. The first air passage 43 is an air passage that guides air from the first opening 41 to the adsorbent module accommodation portion 45. The second air passage 44 is an air passage through which the air flowing from the adsorbent module accommodation portion 45 is discharged from the second opening 42.

The blower 10 for drawing the air into the first air passage 43 from the first opening 41 is located in the first air passage 43. The air, which is drawn by the blower 10 into the first air passage 43 through the first opening 41 located on one end of the casing 40, flows through the adsorbent module accommodation portion 45, turns around at the other end of the casing 40, and then flows out of the casing 40 through the second air passage 44 and the second opening 42.

The blower 10 is an electric blower in which an axial fan is driven by an electric motor. A rotational speed of the fan of the blower 10 is controlled by a control voltage output from a controller 50. The direction of the air flow can be reversed by switching the rotation direction of the electric motor of the blower 10 by the controller 50.

For example, when the electric motor is rotated in a normal direction by the controller 50, the air is drawn into the casing 40 through the first opening 41 and the first air passage 43 and is discharged from the second opening 42 through the adsorbent module accommodation portion 45 and the second air passage 44.

When the electric motor is rotated in a reverse direction by the controller 50, the air is drawn into the casing 40 through the second opening 42 and the second air passage 44 and is discharged from the first opening 41 through the adsorbent module accommodation portion 45 and the first air passage 43.

The casing 40 includes the partition wall 460 that partitions the space inside the casing 40 into a first space 40a and a second space 40b. The partition wall 460 forms a turn portion 40c through which the first space 40a and the second space 40b communicate with each other. The partition wall 460 has an opening portion 46a in which the peltier device 21 is provided.

The peltier device 21 has a heat absorbing side 21b and a heat generating side 21a. When electric current flows in a junction between different metals, the absorbing side 21b absorbs heat, and the heat generating side 21a generates heat due to the heat transferred from the heat absorbing side 21b. The peltier device 21 is provided in the casing 40 such that the heat generating side 21a is located in the first air passage 43 and the heat absorbing side 21b is located in the second air passage 44. The heat generating side 21a is located in the first space 40a partitioned by the partition wall 460, and the heat absorbing side 21b is located in the second space 40b partitioned by the partition wall 460. The electric current flowing in the peltier device 21 is controlled by the controller 50. When the electric current flows in the peltier device 21, the temperature of the absorbing side 21b decreases, and the temperature of the heat generating side 21a increases due to the heat transfer from the heat absorbing side 21b.

A heat radiation side fin 22, which enhances the radiation of the heat generated in the heat generating side 21a to the air, is fixed to the heat generating side 21a. The heat radiation side fin 22 includes multiple needle-shape protrusions like a frog pinholder. The heat generating side 21a is a part of a wall surface of the first air passage 43. The heat generating side 21a and the heat radiation side fin 22 constitute a heating portion 24 that enhances heating of the air flowing through the first air passage 43. The heat radiation side fin 22 is a heat radiation member that is fixed to the heat generating side 21a and radiates the heat of the heat generating side 21a to air in the first air passage 43.

A heat absorbing side fin 23, which enhances heat absorption, is fixed to the heat absorbing side 21b. The heat absorbing side fin 23 includes multiple needle-shape protrusions like a frog pinholder. The heat absorbing side 21b is a part of a wall surface of the second air passage 44. The heat absorbing side 21b and the heat absorbing side fin 23 constitute a cooling portion 25 that cools the air passing through the second air passage 44. The heat absorbing side fin 23 is a cooling member that is fixed to the heat absorbing side 21b and cools the air flowing through the second air passage 44.

The adsorbent module 30 is accommodated in the adsorbent module accommodation portion 45 of the casing 40. The adsorbent module 30 includes an adsorbent 30a, releases moisture adsorbed by the adsorbent 30a to the air, and adsorbs moisture in the air to the adsorbent 30a. The air can flow through the adsorbent 30a. The adsorbent module 30 is replaceable.

The controller 50 is configured as a computer including a CPU, a memory, an I/O, and the like. The controller 50 performs processes based on programs stored in the memory.

Next, the operation of the humidifying device 1 will be described. The humidifying device 1 is actuated when an operation switch (not shown) is turned on by an occupant in a condition where the temperature of the passenger compartment is controlled by a vehicle air conditioning device, for example.

For example, the humidifying device 1 is actuated when the outside air temperature is relatively low and the passenger compartment is likely to be dry, for example, during winter. Therefore, the following description about the operation of the humidifying device 1 is made with the assumption that the outside air temperature is 5 degrees Celsius, the temperature in the passenger compartment is controlled to 25 degrees Celsius, and the relative humidity in the passenger compartment is 20%.

When the operation switch of the humidifying device 1 is turned on, the controller 50 alternately switches the rotation direction of the electric motor of the blower 10 every predetermined time, for example. Accordingly, the air flow path in which the air flows as indicated by an arrow R1 of FIG. 1 and the air flow path in which the air flows as indicated by an arrow R2 of FIG. 2 are switched with each other every predetermined time.

First, the situation where the controller 50 controls the electric motor of the blower 10 to rotate in the normal direction will be described. When the controller 50 controls the electric motor of the blower 10 to rotate in the normal direction, the air in the passenger compartment that is controlled to be at 25 degrees Celsius is drawn into the first air passage 43 of the casing 40 of the humidifying device 1 through the first opening 41. When the controller 50 causes a predetermined electric current to flow in the peltier device 21, the temperature of the heat absorbing side 21b of the peltier device 21 decreases, and the temperature of the heat generating side 21a of the peltier device 21 increases. Accordingly, the air drawn into the first air passage 43 is heated by the heating portion 24 including the heat generating side 21a of the peltier device 21 and the heat radiation side fin 22. According to this, the temperature of the air that has flown through the heating portion 24 increases to about 40 degrees Celsius, for example.

The air that has passed through the heating portion 24 flows into the adsorbent module accommodation portion 45. At this time, a relative humidity of the air whose temperature has increased while passing through the heating portion 24 is lower than a relative humidity of the air in the passenger compartment. Accordingly, since the air that has passed through the heating portion 24 to be low relative humidity contacts the adsorbent 30a, the moisture adsorbed on the adsorbent 30a is easily desorbed into the air. That is, the air whose relative humidity is decreased by the heating portion 24 is likely to take the moisture held by the adsorbent 30a, and the air that has passed through the adsorbent module accommodation portion 45 is sufficiently humidified.

Since the humidified air is cooled by the cooling portion 25 having the heat absorbing side 21b of the peltier device 21 and the heat absorbing side fin 23, the temperature of the humidified air that has increased by the heating portion 24 decreases. According to this, the cool humidified air can be supplied toward the occupant through the second opening 42. In a desorption time of the humidifying device 1, the air is sufficiently humidified by the adsorbent module 30 after heated by the heating portion 24, and then the air is cooled by the cooling portion 25. Accordingly, the humidified air can be supplied to improve the comfort of the occupant.

In the desorption time, since the air is heated by the heating portion 24 before the air flows through the adsorbent module accommodation portion 45 in which the adsorbent module 30 is accommodated, the temperature of the air can be quickly increased. Further, since the temperature of the air is quickly increased, the relative humidity of the air can be quickly decreased. Accordingly, the moisture is actively desorbed from the adsorbent 30a, and the relative humidity of the air that has flown out of the adsorbent module accommodation portion 45 in which the adsorbent module 30 is accommodated can be quickly increased.

Next, the situation where the controller 50 controls the electric motor of the blower 10 to rotate in the reverse direction will be described. When the controller 50 controls the electric motor of the blower 10 to rotate in the reverse direction, the air in the passenger compartment that is controlled to be at 25 degrees Celsius is drawn into the second air passage 44 of the casing 40 of the humidifying device 1 through the second opening 42. The air drawn into the second air passage 44 is cooled while passing through the cooling portion 25 including the heat absorbing side 21b of the peltier device 21 and the heat absorbing side fin 23.

The air that has passed through the cooling portion 25 flows into the adsorbent module accommodation portion 45 accommodating the adsorbent module 30. At this time, the relative humidity of the air whose temperature has decreased while passing through the cooling portion 25 is higher than the relative humidity of the air in the passenger compartment. Since the air whose relative humidity is higher than that of the passenger compartment contacts the adsorbent 30a, the moisture in the air is likely to be adsorbed to the adsorbent 30a. That is, the moisture in the air whose relative humidity is increased by the cooling portion 25 is likely to be adsorbed by the adsorbent 30a, and accordingly the air that has passed through the adsorbent module accommodation portion 45 accommodating the adsorbent module 30 is sufficiently dehumidified.

Further, the air that has flown out of the adsorbent module accommodation portion 45 accommodating the adsorbent module 30 is heated while passing through the heating portion 24 including the heat generating side 21a of the peltier device 21 and the heat radiation side fin 22, and the air flows through the first opening 41 toward the rear seat or the lower part of the passenger compartment not toward the upper body of the occupant.

In the adsorbing time, since the air is cooled by the cooling portion 25 before the air flows through the adsorbent module accommodation portion 45 in which the adsorbent module 30 is accommodated, the temperature of the air can be quickly decreased. Further, since the temperature of the air is quickly decreased, the relative humidity of the air can be quickly increased. Accordingly, the moisture is actively adsorbed to the adsorbent 30a, and the relative humidity of the air that has flown out of the adsorbent module 30 is accommodated can be quickly decreased.

As described above, the humidifying device 1 includes the casing 40 defining: the first air passage 43 through which the air flows into the adsorbent module accommodation portion 45 in which the adsorbent module 30 including the adsorbent 30a is accommodated; and the second air passage 44 through which the air flows out of the adsorbent module accommodation portion 45. Further, the humidifying device 1 includes the peltier device 21 which has the heat absorbing side 21b and the heat generating side 21a. When electric current flows in a junction between different metals, the absorbing side 21b absorbs heat, and the heat generating side 21a generates heat due to the heat transferred from the heat absorbing side 21b. The peltier device 21 is provided in the casing 40 such that the heat generating side 21a is located in the first air passage 43 and the heat absorbing side 21b is located in the second air passage 44.

If the heater that is a heating device and a cooling device are independently provided, the size may be large, and energy may be wasted.

According to the present embodiment, the heat absorption from the air flowing through the second air passage 44 and the heating of the air in the first air passage 43 can be performed by the peltier device 21 which includes the heat absorbing side 21b absorbing heat in response to the electric current flowing through the junction between different metals and the heat generating side 21a that generates heat due to the heat transferred from the heat absorbing side 21b. Therefore, power consumption can be reduced along with downsizing.

The casing 40 includes the partition wall 460 that partitions the space inside the casing 40 into the first space 40a and the second space 40b. The partition wall 460 forms the turn portion 40c through which the first space 40a and the second space 40b communicate with each other. The peltier device 21 is provided in the partition wall 460. The heat generating side 21a is located in the first space 40a partitioned by the partition wall 460, and the heat absorbing side 21b is located in the second space 40b partitioned by the partition wall 460.

The peltier device 21 is provided in the partition wall 460, the heat generating side 21a is located in the first space 40a, and the heat absorbing side 21b is located in the second space 40b. Therefore, the configuration of the humidifying device 1 can be simplified.

Further, since the heat radiation side fin 22, which is a heat radiation member fixed on the heat generating side 21a to radiate heat of the heat generating side 21a to the air in the first air passage 43, is provided, the air in the first air passage 43 can be efficiently heated.

Further, since the heat absorbing side fin 23, which is a cooling member fixed on the heat absorbing side 21b to cool the air in the second air passage 44, is provided, the air in the second air passage 44 can be efficiently cooled.

The adsorbent module accommodation portion 45 may be provided in the passage extending from the heat radiation side fin 22 to the heat absorbing side fin 23 through the turn portion 40c.

### Second Embodiment

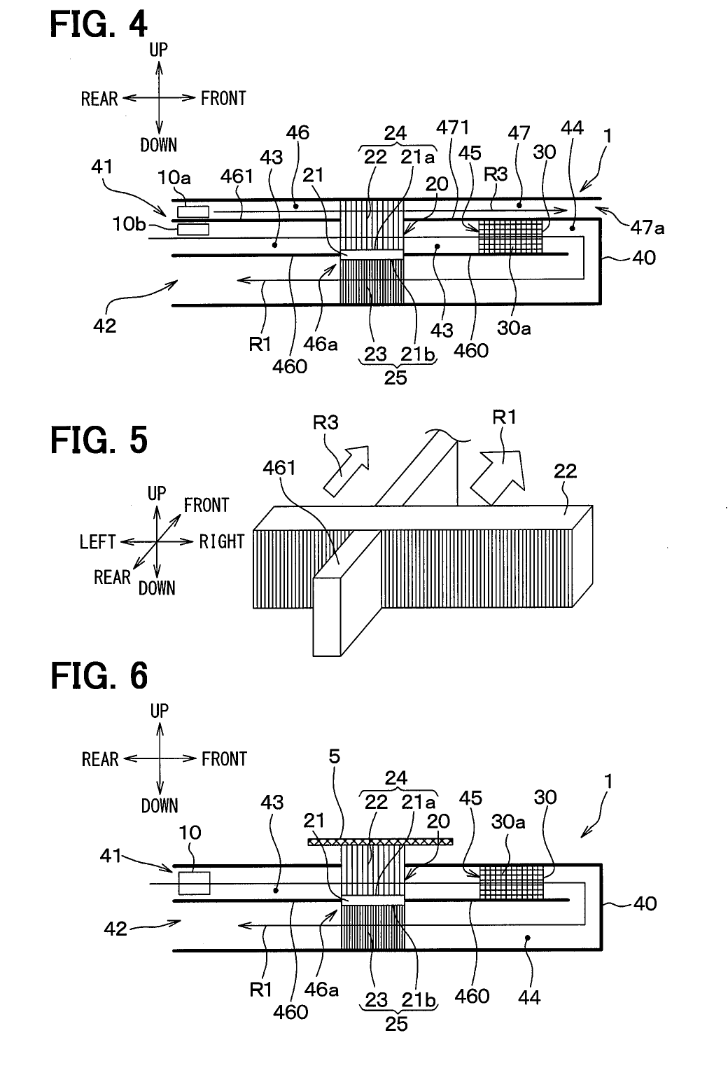

A humidifying device 1 according to a second embodiment will be described with reference to FIG. 4. FIG. 4 is a diagram illustrating a humidifying device 1 of the present embodiment. The humidifying device 1 of the first embodiment is formed such that all of the air flowing through the heat radiation side fin 22 flows through the first air passage 43 and the adsorbent module accommodation portion 45.

In contrast, the humidifying device 1 of the present embodiment is formed such that a part of the air flowing through the heat radiation side fin 22 flows out of the casing 40 without passing through the adsorbent module accommodation portion 45 or the second air passage 44.

Specifically, the casing 40 additionally defines a third air passage 46 through which the air flows into the casing 40, and a fourth air passage 47 through which the air flowing through the third air passage 46 and a part of the heat radiation side fin 22 flows out of the casing 40 without passing through the adsorbent module accommodation portion 45 or the second air passage 44. The fourth air passage 47 corresponds to a waste heat air passage.

Further, a blower 10b is provided in the first air passage 43, and a blower 10a is provided in the third air passage 46. Further, a partition wall 461 is provided between the first air passage 43 and the third air passage 46, and a partition wall 471 is provided between the second air passage 44 and the fourth air passage 47.

The air flowing through the first air passage 43 and the third air passage 46 flows through the heat radiation side fin 22. The air flowing through the first air passage 43 mainly flows through a lower part of the heat radiation side fin 22, and the air flowing through the third air passage 46 mainly flows through an upper part of the heat radiation side fin 22.

Accordingly, a part of the air flowing through the heat radiation side fin 22 flows through the adsorbent module accommodation portion 45 and the second air passage to be discharged through the second opening 42, and the remaining parts of the air flowing through the heat radiation side fin 22 flows through the fourth air passage 47 to be discharged through an opening 47a.

The peltier device 21 is an element utilizing the Peltier effect in which heat is transferred from one metal to the other metal when electric current flows through the junction of the metals. In the peltier device 21, Joule heat due to internal resistance is generated as well as the movement of the heat from one metal to the other metal. Accordingly, the heat radiation capacity of the peltier device 21 is larger than the cooling capacity. Further, the amount of heat generated in the junction and heat absorption of the peltier device 21 is proportional to the electric current flowing in the junction.

Accordingly, if the electric current flows in the peltier device 21 such that the cooling capacity of the peltier device 21 is appropriate, the heat radiation capacity of the peltier device 21 may be too large, for example. It may be assumed as a method for increasing the heat radiation amount of the peltier device 21 to increase the flow rate of the air flowing through the heat radiation side fin 22. However, if the flow rate of the air flowing through the heat radiation side fin 22 is increased, the flow rate of the air flowing through the heat absorbing side fin 23 is also increased, and accordingly the cooling capacity may not be maintained to be appropriate.

According to the humidifying device 1 of the present embodiment, the casing 40 defines the fourth air passage 47 through which a part of the air heated by the heat radiation side fin 22 bypasses the adsorbent module accommodation portion 45 accommodating the adsorbent module 30 and is discharged from the casing 40.

A part of the air flowing through the heat radiation side fin 22 can be discharged from the casing 40 through the fourth air passage 47. Therefore, the heat can be sufficiently radiated from the heat radiation side fin 22 in the adsorbing time, and the heat is sufficiently absorbed from the heat absorbing side fin 23. Accordingly, the moisture can be preferably adsorbed to the adsorbent 30a. Therefore, the appropriate cooling capacity, i.e. dehumidifying capacity, can be obtained without increasing the flow rate of the air flowing through the heat absorbing side fin 23.

The humidifying device 1 of the present embodiment is configured such that the ratio between the flow rate of the air flowing through the first air passage 43 and the flow rate of the air flowing through the fourth air passage 47 is appropriate in view of COP (Coefficient Of Performance) of the peltier device 21. Specifically, the humidifying device 1 of the present embodiment is configured such that the ratio between the volume of the air blown by the blower 10a and the volume of the air blown by the blower 10b is appropriate.

The present embodiment can achieve the effects and advantages, which are obtained from the structure common to the first embodiment.

### Third Embodiment

A humidifying device 1 according to a third embodiment will be described with reference to FIG. 5. FIG. 5 is a diagram illustrating the heat radiation side fin 22 and the partition wall 460 of the humidifying device 1 of the present embodiment. In the humidifying device 1 of the second embodiment, the partition wall 461 sections the heat radiation side fin 22 into the upper part and the lower part. The air flowing through the first air passage 43 mainly flows through a lower part of the heat radiation side fin 22, and the air flowing through the third air passage 46 mainly flows through an upper part of the heat radiation side fin 22.

In contrast, in the humidifying device 1 of the present embodiment, the partition wall 461 sections the heat radiation side fin 22 into a left side part and a right side part. The air flowing through the first air passage 43 mainly flows through the right side part of the heat radiation side fin 22 as indicated by an arrow R1 of FIG. 5, and the air flowing through the third air passage 46 mainly flows through the left side part of the heat radiation side fin 22 as indicated by an arrow R3. The partition wall 461 may be configured to section the heat radiation side fin 22 into the left side part and the right side part as described above.

The present embodiment can achieve the effects and advantages, which are obtained from the structure common to the first embodiment.

### Fourth Embodiment

A humidifying device 1 according to a fourth embodiment will be described with reference to FIG. 6. FIG. 6 is a diagram illustrating a humidifying device 1 of the present embodiment. In the humidifying device 1 of the first embodiment, the heat radiation side fin 22 is accommodated in the first air passage 43 of the casing 40.

In contrast, in the humidifying device 1 of the present embodiment, a part of the heat radiation side fin 22 protrudes to an outside of the casing 40, and the part of the heat radiation side fin 22 protruding outside the casing 40 is in contact with a ceiling 5 of a vehicle.

According to this, the heat of the heat radiation side fin 22 is transferred to the ceiling 5, and the heat of the heat generating side 21a of the peltier device 21 can be effectively dissipated. Furthermore, the heat radiation side fin 22 can also be miniaturized.

The present embodiment can achieve the effects and advantages, which are obtained from the structure common to the first embodiment.

### Fifth Embodiment

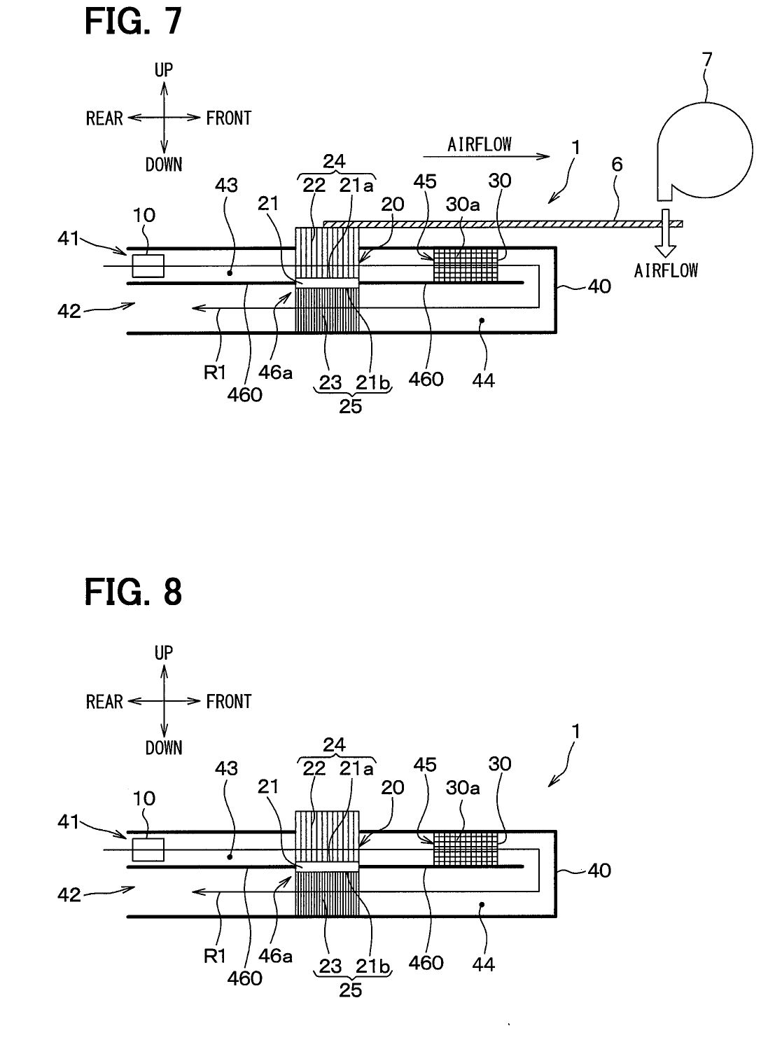

A humidifying device 1 according to a fifth embodiment will be described with reference to FIG. 7. FIG. 7 is a diagram illustrating a humidifying device 1 of the present embodiment. In the humidifying device 1 of the fourth embodiment, a part of the heat radiation side fin 22 protrudes to the outside of the casing 40, and the part of the heat radiation side fin 22 protruding outside the casing 40 is in contact with the ceiling 5 of a vehicle.

In contrast, in the humidifying device 1 of the present embodiment, a part of the heat radiation side fin 22 protrudes to the outside of the casing 40, and the part of the heat radiation side fin 22 protruding outside the casing 40 is in contact with a heat pipe 6 that is cooled by an air blown by a blower 7 for air-conditioning of the passenger compartment.

As described above, the part of the heat radiation side fin 22 protruding outside the casing 40 may be in contact with the heat pipe 6 that is cooled by the air blown by the blower 7 for air-conditioning of the vehicle.

According to this, a part of the heat radiation side fin 22 can be cooled by the blower 7 that is disposed away from the humidifying device 1. Furthermore, the heat radiation side fin 22 can also be miniaturized.

The present embodiment can achieve the effects and advantages, which are obtained from the structure common to the first embodiment.

### Other Embodiments

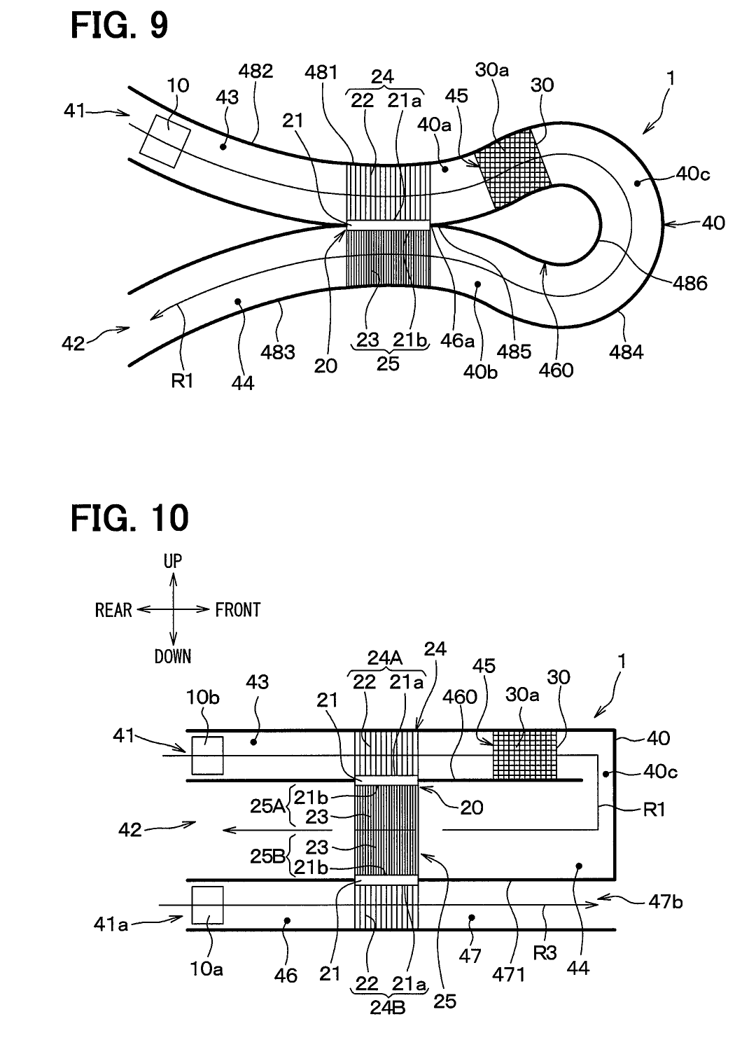

(1) In the above-described embodiments, examples where the humidifying device 1 is mounted on the vehicle are described. However, the humidifying device 1 may be used in a house or a movable object other than a vehicle.
(2) In the above-described second embodiment, the third air passage 46 through which the air flows into the casing 40 and the blower 10a for blowing the air into the third air passage 46 are provided. However, the third air passage 46 and the blower 10a may be omitted. That is, a part of the air flowing into the heat radiation side fin 22 through the first air passage 43 may flow through the adsorbent module accommodation portion 45 and the second air passage to be discharged through the second opening 42, and the remaining parts of the air flowing into the heat radiation side fin 22 may flow through the fourth air passage 47 to be discharged through an opening 47a. Similarly, the fourth air passage 47 may be omitted. In FIG. 8, a configuration in which the third air passage 46, the blower 10a, and the fourth air passage 47 are omitted is illustrated. According to this configuration, the part of the heat radiation side fin 22 protruding outside the casing 40 is naturally radiated to the air around the part of the heat radiation side fin 22. Therefore, the heat can be sufficiently radiated from the heat radiation side fin 22 in the adsorbing time, and the heat is sufficiently absorbed from the heat absorbing side fin 23. Accordingly, in the adsorbing time, the moisture can be preferably adsorbed to the adsorbent 30a.
(3) In the humidifying device of the fourth embodiment, a part of the heat radiation side fin 22 protrudes to the outside of the casing 40, and the part of the heat radiation side fin 22 protruding outside the casing 40 is in contact with the ceiling 5 of a vehicle. The part of the heat radiation side fin 22 protruding outside the casing 40 may be in contact with a vehicle body, for example.
(4) In the above-described embodiments, the heat radiation side fin 22 and the heat absorbing side fin 23 have multiple needle-shaped protrusions like a flower pin holder. However, the shape of the fins is not limited to this.
(5) In the above-described embodiments, the blower 10 is an axial fan type blower. However, the blower 10 is not limited to the axial fan type, but a centrifugal blower or scroll type blower may be used as the blower 10. The blower 10 may be located anywhere in the passage constituted by the first air passage 43 and the second air passage 44.
(6) The configuration of the casing 40 is not limited to the specific examples described in the above-described embodiments. A modification example of the casing 40 of the first embodiment illustrated in FIG. 1 is shown in FIG. 9.

In FIG. 9, a situation in the humidification mode is illustrated, as in FIG. 1. The humidification mode is an operation mode corresponding to the desorption time of the first embodiment. That is, the humidification mode is an operation mode in which the controller 50 controls the the electric motor to rotate in the normal direction as shown in FIG. 2. In the humidification mode, the air in the passenger compartment is drawn into the casing 40 through the first opening 41. The air drawn into the casing 40 through the first opening 41 is discharged through the second opening 42 after being humidified by the adsorbent module 30.

In contrast, an operation mode in which the controller 50 shown in FIG. 2 controls the electric motor to rotate in the reverse direction is a dehumidification mode. The dehumidification mode is an operation mode corresponding to the adsorption time of the first embodiment. In the dehumidification mode, the air in the passenger compartment is drawn into the casing 40 through the second opening 42. The air drawn into the casing 40 through the second opening 42 is discharged through the first opening 41 after being dehumidified by the adsorbent module 30. That is, the dehumidification mode is an operation mode in which the moisture supplied to the air in the humidification mode is preliminarily recovered from the air in the passenger compartment.

As shown in FIG. 9, the casing 40 of the modification example includes an device holding portion 481, a low humidity side pipe portion 482, a high humidity side pipe portion 483, and a communication pipe portion 484.

The device holding portion 481 is configured to hold a heat transfer mechanism 20. In the heat transfer mechanism 20, the heat radiation side fin 22 is connected to the heat generating side 21a that is one side of the peltier device 21, and the heat absorbing side fin 23 is connected to the heat absorbing side 21b that is the other side of the peltier device 21. That is, the heat transfer mechanism 20 is a unit having the heating portion 24 on the one side of the peltier device 21 and the cooling portion 25 on the other side of the peltier device 21. Accordingly, the device holding portion 481 is a part of the casing 40 holding the heating portion 24 and the cooling portion 25.

The low humidity side pipe portion 482 is a part through which the air whose humidity is lower than that of the air flowing through the high humidity side pipe portion 483. The low humidity side pipe portion 482 is connected to the heating portion 24. The air whose humidity is lower than that of the air flowing through the high humidity side pipe portion 483 is the air before being humidified by the adsorbent module 30 in the humidification mode. In contrast, in the dehumidification mode, the air whose humidity is lower than that of the air flowing through the high humidity side pipe portion 483 is the air after being dehumidified by the adsorbent module 30. That is, the first air passage 43 is defined inside the low humidity side pipe portion 482.

The high humidity side pipe portion 483 is a part through which the air whose humidity is higher than that of the air flowing through the low humidity side pipe portion 482. The high humidity side pipe portion 483 is connected to the cooling portion 25. The air whose humidity is higher than that of the air flowing through the low humidity side pipe portion 482 is the air after being humidified by the adsorbent module 30 in the humidification mode. In contrast, in the dehumidification mode, the air whose humidity is higher than that of the air flowing through the low humidity side pipe portion 482 is the air before being dehumidified by the adsorbent module 30. That is, the second air passage 44 is defined inside the high humidity side pipe portion 483.

An end portion of the device holding portion 481 is branched into the low humidity side pipe portion 482 and the high humidity side pipe portion 483. The other end portion of the device holding portion 481 is connected to the communication pipe portion 484.

The communication pipe portion 484 is a pipe-shape part having an approximately U-shape and connecting the heating portion 24 and the cooling portion 25. The communication pipe portion 484 defines the adsorbent module accommodation portion 45. That is, in the humidification mode, the communication pipe portion 484 guides the air, which has passed through the heating portion 24 and heated, to the adsorbent module 30 and the humidified air, which has passed through the adsorbent module 30, to the cooling portion 25. In contrast, in the dehumidification mode, the communication pipe portion 484 guides the air, which has passed through the cooling portion 25 and cooled, to the adsorbent module 30 and the dehumidified air, which has passed through the adsorbent module 30, to the heating portion 24.

The turn portion 40c is defined inside the communication pipe portion 484. The partition wall 460 is a part of the wall of the casing 40 that is the communication pipe portion 484. The partition wall 460 is surrounded by an approximately U-shape air passage. The partition wall 460 includes a first partition wall 485 and a second partition wall 486.

The first partition wall 485 is a plate-shape part in which the peltier device 21 is provided, and the first partition wall 485 has an opening 46a. The second partition wall 486 has a teardrop like cylinder shape formed by bending a flat plate into U-shape to join both ends. In the modification example, the partition wall 460, i.e. the first partition wall 485 and the second partition wall 486, partitions the space in the casing 40 into the first space 40a and the second space 40b, and the partition wall 460 forms the turn portion 40c through which the first space 40a and the second space communicate with each other.

According to such a configuration, the same effect obtained from the same configuration as the first embodiment can be obtained in the same manner as the first embodiment.

(7) The configuration shown in FIG. 10 is a modification of the configuration of the second embodiment shown in FIG. 4. In FIG. 10, a situation in the humidification mode is illustrated, as in FIGS. 1, 4.

As shown in FIG. 10, in the present modification example, the casing 40 includes the third air passage 46 and the fourth air passage 47 in addition to the first air passage 43 and the second air passage 44. The casing 40 has a third opening 41a and a waste heat opening 47b in addition to the first opening 41 and the second opening 42.

The third air passage 46 introduces air into the casing 40 from the third opening 41a provided separately from the first opening 41 without passing through the first air passage 43 or the second air passage 44. The fourth air passage 47 is provided to discharge the air introduced into the third air passage 46 from the waste heat opening 47b to the outside of the casing 40 without passing through the first air passage 43 or the second air passage 44. The fourth air passage 47 corresponds to a waste heat air passage. The third air passage 46 and the fourth air passage 47 communicate with each other. The waste heat opening 47b is the same as the opening 47a of the second embodiment shown in FIG. 4.

In the casing 40 of the present modification example, the second air passage 44 is located between the first air passage 43 and the third air passage 46. Further, in the casing 40, the second air passage 44 is located between the first air passage 43 and the fourth air passage 47.

In the present modification example, the heat radiation side fin 22 through which the air flowing through the first air passage 43 passes and the heat radiation side fin 22 through which the air flowing through the third air passage 46 passes are separately provided. The peltier device 21 and the heat absorbing side fin 23 are provided corresponding to the heat radiation side fin 22 through which the air flowing through the first air passage 43 passes. Similarly, the peltier device 21 and the heat absorbing side fin 23 are provided corresponding to the heat radiation side fin 22 through which the air flowing through the third air passage 46 passes. These two heat absorbing side fins 23 are provided to cool the air flowing through the second air passage 44.

That is, in the configuration shown in FIG. 10, two sets of heat transfer mechanisms 20 formed by joining the heat radiation side fin 22 and the heat absorbing side fin 23 on both sides of the peltier device 21 are mounted on the casing 40. The heat absorbing sides 21b of the two heat transfer mechanisms 20 face each other in the second air passage 44. The heat generating side 21a of one of the two heat transfer mechanisms 20 is disposed in the first air passage 43. In contrast, the heat generating side 21a of the other one of the two heat transfer mechanisms 20 is disposed in the third air passage 46 and the fourth air passage 47.

That is, the heating portion 24 includes a first heating portion 24A and a second heating portion 24B. The first heating portion 24A includes the heat generating side 21a of one peltier device 21 and the heat radiation side fin 22 fixed to the heat generating side 21a. The second heating portion 24B includes the heat generating side 21a of the other one peltier device 21 and the heat radiation side fin 22 fixed to the heat generating side 21a.

Similarly, the cooling portion 25 includes a first cooling portion 25A and a second cooling portion 25B. The first cooling portion 25A includes the heat absorbing side 21b of one peltier device 21 and the heat absorbing side fin 23 fixed to the heat absorbing side 21b. The second cooling portion 25B includes the heat absorbing side 21b of the other one peltier device 21 and the heat absorbing side fin 23 fixed to the heat absorbing side 21b.

The heat generating side 21a of the peltier device 21 corresponding to the first heating portion 24A is disposed in the first air passage 43. Further, the heat generating side 21a is joined to the heat radiation side fin 22 which radiates the heat of the heat generating side 21a to the air in the first air passage 43. The heat generating side 21a of the peltier device 21 corresponding to the second heating portion 24B is disposed in the third air passage 46 and the fourth air passage 47. Further, the heat generating side 21a is joined to the heat radiation side fin 22 which radiates the heat of the heat generating side 21a to the air in the third air passage 46 and the fourth air passage 47.

The heat absorbing side fin 23 in the first cooling portion 25A and the heat absorbing side fin 23 in the second cooling portion 25B are accommodated in the second air passage 44 and are in contact with each other. The heat absorbing side fin 23 of the first cooling portion 25A and the heat absorbing side fin 23 of the second cooling portion 25B may be integrated with each other. Alternatively, the heat absorbing side fin 23 of the first cooling portion 25A may double as the heat absorbing side fin 23 of the second cooling portion 25B.

According to the configuration shown in FIG. 10, in the humidification mode, the controller 50 causes the electric motor of the blower 10b provided in the first air passage 43 to rotate in the normal direction. Then, the air in the passenger compartment is drawn into the first air passage 43 of the casing 40 of the humidifying device 1 through the first opening 41. At the same time, the controller 50 causes the electric motor of the blower 10a provided in the third air passage 46 to rotate in the normal direction. Then, the air in the passenger compartment is drawn into the third air passage 46 of the casing 40 of the humidifying device 1 through the third opening 41a.

Further, the controller 50 supplies a predetermined electric current to the pair of peltier devices 21. Then, the temperature of the heat absorbing sides 21b of the peltier devices 21 decreases, and the temperature of the heat generating sides 21a of the peltier devices 21 increases. As a result, the heat generated on the heat generating sides 21a is transferred to the heat radiation side fins 22 of the first heating portion 24A and the second heating portion 24B, whereby the temperature of the heat radiation side fins 22 also increases. In contrast, the temperature of the heat absorbing side fins 23 is also lowered by transferring the heat generated on the heat absorbing sides 21b to the heat absorbing side fins 23 provided in the first cooling portion 25A and the second cooling portion 25B.

The air drawn into the first air passage 43 is heated by the first heating portion 24A. According to this, the temperature of the air that has flown through the first heating portion 24A increases to about 40 degrees Celsius, for example.

The air that has passed through the first heating portion 24A flows into the adsorbent module accommodation portion 45. At this time, a relative humidity of the air whose temperature has increased while passing through the first heating portion 24A is lower than a relative humidity of the air in the passenger compartment. Accordingly, since the air that has passed through the first heating portion 24A to be low relative humidity contacts the adsorbent 30a, the moisture adsorbed on the adsorbent 30a is easily desorbed into the air. That is, the air whose relative humidity is decreased by the first heating portion 24A is likely to take the moisture held by the adsorbent 30a, and the air that has passed through the adsorbent module accommodation portion 45 is sufficiently humidified. The humidified air reaches the second air passage 44 through the turn portion 40c.

As the air drawn into the first air passage 43 passes through the first heating portion 24A and rises in temperature, the heat radiation side fin 22 provided in the first heating portion 24A is cooled. As a result, the temperature of the heat absorbing side fin 23 provided in the first cooling portion 25A can be favorably lowered.

Further, the air drawn into the third air passage 46 reaches the second heating portion 24B. The air reaching the second heating portion 24B cools the heat radiation side fin 22 provided in the second heating portion 24B, and then is discharged to the outside of the casing 40 from the waste heat opening 47b through the fourth air passage 47. Thereby, the temperature of the heat absorbing side fin 23 provided in the second cooling portion 25B can be favorably lowered.

Since the humidified air drawn into the second air passage 44 is cooled by the first cooling portion 25A and the second cooling portion 25B, the humidified air whose temperature has increased by the first heating portion 24A is lowered. According to this, the cool humidified air can be supplied toward the occupant through the second opening 42. In the humidification mode, the blower 10a provided in the third air passage 46 may be stopped according to the operating conditions.

According to the configuration shown in FIG. 10, in the dehumidification mode, the controller 50 causes the electric motor of the blower 10b provided in the first air passage 43 to rotate in the reverse direction. Then, the air in the passenger compartment is drawn into the second air passage 44 of the casing 40 of the humidifying device 1 through the second opening 42. At the same time, the controller 50 causes the electric motor of the blower 10a provided in the third air passage 46 to rotate in the normal direction. Then, the air in the passenger compartment is drawn into the third air passage 46 of the casing 40 of the humidifying device 1 through the third opening 41a. Further, the controller 50 supplies a predetermined electric current to the pair of peltier devices 21.

When the a predetermined electric current flows in the pair of the peltier devices 21, the temperature of the heat absorbing side 21b of the peltier device 21 decreases, and the temperature of the heat generating side 21a of the peltier device 21 increases. As a result, the heat generated on the heat generating sides 21a is transferred to the heat radiation side fins 22 of the first heating portion 24A and the second heating portion 24B, whereby the temperature of the heat radiation side fins 22 also increases. In contrast, the temperature of the heat absorbing side fins 23 is also lowered by transferring the heat generated on the heat absorbing sides 21b to the heat absorbing side fins 23 provided in the first cooling portion 25A and the second cooling portion 25B. Furthermore, the heat absorbing side fin 23 of the second cooling portion 25B is cooled well by the heat radiation from the heat radiation side fin 22 of the second heating portion 24B to the air drawn into the third air passage 46.

The air drawn into the second air passage 44 is cooled while passing through the first cooling portion 25A and the second cooling portion 25B. The air that has passed through the first cooling portion 25A and the second cooling portion 25B flows into the adsorbent module accommodation portion 45 accommodating the adsorbent module 30. At this time, the relative humidity of the air whose temperature has decreased while passing through the first cooling portion 25A and the second cooling portion 25B is higher than the relative humidity of the air in the passenger compartment. Since the air whose relative humidity is higher than that of the passenger compartment contacts the adsorbent 30a, the moisture in the air is likely to be adsorbed to the adsorbent 30a. That is, the moisture in the air whose relative humidity is increased by the first cooling portion 25A and the second cooling portion 25B is likely to be adsorbed by the adsorbent 30a, and accordingly the air that has passed through the adsorbent module accommodation portion 45 accommodating the adsorbent module 30 is sufficiently dehumidified.

Further, the air that has flown out of the adsorbent module accommodation portion 45 accommodating the adsorbent module 30 is heated while passing through the first heating portion 24A, and the air flows through the first opening 41 toward the rear seat or the lower part of the passenger compartment not toward the upper body of the occupant.

According to such a configuration, the same effect obtained from the same configuration as the first and second embodiments can be obtained in the same manner as the first and second embodiments.

In particular, according to such a configuration, the cooling performance to the air flowing through the second air passage 44 is significantly improved. Further, also in the adsorption mode, i.e. in the dehumidifying mode, the blower 10a provided in the third air passage 46 is driven in a state where the electric motor is rotated in the normal direction. As a result, the amount of the air blown from the blower 10a to the heat radiation side fin 22 of the second heating portion 24B is favorably secured, and the heat radiation in the heat radiation side fin 22 is performed even better. Since the heat is sufficiently radiated from the heat radiation side fin 22 in the dehumidification mode, the heat is sufficiently absorbed to the heat absorbing side fin 23 provided in the second air passage 44. Accordingly, in the dehumidification mode, the moisture can be preferably adsorbed to the adsorbent 30a.

Thus, according to such a configuration, in the dehumidification mode, it is possible to maintain the optimal cooling capacity, i.e. the hygroscopic capacity, without increasing the volume of the air passing through the heat absorbing side fins 23. Since the capacity to cool the air flowing through the second air passage 44 is significantly improved, the humidifying capacity and the dehumidifying capacity are also significantly improved.

The configuration shown in FIG. 10 can also be modified as appropriate. For example, the third air passage 46 and the fourth air passage 47 may be provided on the right side or the left side of the second air passage 44. The third air passage 46 and the fourth air passage 47 may be provided above the second air passage 44 in parallel with the first air passage 43.

The configuration shown in FIG. 10 and the configurations of the embodiments shown in FIGS. 4 to 7 can be combined as appropriate.

For example, the heat radiation side fin 22 of the first heating portion 24A shown in FIG. 10 may protrude to the outside of the casing 40 as shown in FIGS. 6 to 8. In this case, in the heat radiation side fin 22 provided in the first heating portion 24A, sufficient heat radiation is achieved by heat transfer to the ceiling 5, cooling using the heat pipe 6 and the blower 7, or heat radiation to the outside air. For this reason, the heat absorption in the heat absorbing side fin 23 is sufficiently performed. Accordingly, in the dehumidification mode, the moisture can be preferably adsorbed to the adsorbent 30a.

For example, the heat radiation side fin 22 of the second cooling portion 25B shown in FIG. 10 may protrude to the outside of the casing 40 as shown in FIGS. 6 to 8. In this case, in the heat radiation side fin 22 provided in the second cooling portion 25B, sufficient heat radiation is achieved by heat transfer to the ceiling 5, cooling using the heat pipe 6 and the blower 7, or heat radiation to the outside air. For this reason, the heat absorption in the heat absorbing side fin 23 is sufficiently performed. Accordingly, in the dehumidification mode, the moisture can be preferably adsorbed to the adsorbent 30a.

The present disclosure is not limited to the above described embodiments and may be suitably modified. In addition, the embodiments described above are not independent of one another, and can be appropriately combined except a case where a combination is apparently impossible. In each of the above embodiments, it is needless to say that elements constituting the embodiments are not necessarily indispensable except a case of being specified to be particularly indispensable and a case where it is considered to be obviously indispensable in principle. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. The materials, shapes, positional relationships, or other conditions of the constituent elements and the like described in the respective embodiments are not limited to specific materials, shapes, positional relationships, or other conditions unless clearly expressed, or limited to the specific materials, shapes, positional relationships, or other conditions in principle.

### CONCLUSION

According to an aspect described in a part or all of the above embodiment, the humidifying device (1) includes: the casing (40) the first air passage (43) that guides air to the adsorbent module accommodation portion (45) accommodating the adsorbent module (30) including an adsorbent (30a), and the second air passage (44) through which the air flowing out of the adsorbent module accommodation portion flows; and the peltier device (21) that has the heat absorbing side (21b) absorbing heat according to an electric current flowing in the junction of different metals, and the heat generating side (21a) generating heat due to heat transfer from the heat absorbing side. The peltier device is housed in the casing such that the heat generating side is located in the first air passage and the heat absorbing side is located in the second air passage.

According to a second aspect, the casing includes the partition wall (460) that partitions a space inside the casing into the first space (40a) and the second space (40b), and the partition wall defines the turn portion (40c) through which the first space and the second space communicate with each other. The peltier device is provided in the partition wall. The heat generating side is located in the first space partitioned by the partition wall, and the heat absorbing side is located in the second space partitioned by the partition wall.

According to this, the peltier device is provided in the partition wall, the heat generating side is located in the first space, and the heat absorbing side is located in the second space. Accordingly, the configuration can be simplified.

According to a third aspect, the humidifying device includes the heat radiation member (22) fixed to the heat generating side, and the heat radiation member is configured to radiate the heat of the heat generating side to the air in the first air passage. According to this, since the heat radiation member (22) through which the heat of the heat generating side is radiated to the air in the first air passage is provided, the air in the first air passage can be efficiently heated.

According to a fourth aspect, the humidifying device includes the cooling member (23) fixed to the heat absorbing side, and the cooling member is configured to cool the air in the second air passage. According to this, since the cooling member (23) that cools the air in the second air passage is provided, the air in the second air passage can be efficiently cooled.

According to a fifth aspect, the adsorbent module accommodation portion is located in an air passage extending from the heat radiation member to the cooling member through the turn portion. The adsorbent module accommodation portion may be provide in an air passage extending from the heat radiation member to the cooling member through the turn portion.

According to a sixth aspect, the humidifying device includes the heat radiation member (22) fixed to the heat generating side, and the heat radiation member is configured to radiate the heat of the heat generating side to the air in the first air passage. The casing defines the waste heat air passage (47) through which a part of the air passing through the heat radiation member flows out of the casing without flowing through the adsorbent module accommodation portion or the second air passage. Accordingly, appropriate cooling capacity can be maintained without increasing the flow rate of the air flowing through the heat absorbing side fin 23.

According to a seventh aspect, a part of the heat radiation member protrudes to an outside of the casing. According to this, the heat of the heat radiation side of the peltier device can be transferred to an object outside the casing by contacting the part of the heat radiation member protruding outside the casing to the object.

According to an eighth aspect, the humidifying device is mounted on a vehicle, and the part of the heat radiation member protruding to the outside of the casing is in contact with a part (5) of the vehicle. According to this, the heat of the heat radiation member is transferred to the part of the vehicle, and the heat of the heat radiation side of the peltier device can be effectively radiated.

According to a ninth aspect, the humidifying device is mounted on a vehicle, and the part of the heat radiation member protruding to the outside of the casing is in contact with a component (6) that is cooled by a blower (7) for air-conditioning of the vehicle.

According to this, the heat of the heat radiation member is transferred to the component that is cooled by the air blown by the blower (7), and the heat of the heat radiation side of the peltier device can be radiated effectively. Further, even when the blower is disposed away from a part of the heat radiation member, the heat of the heat generating side of the peltier device can be radiated.

According to a tenth aspect, the casing includes the third air passage (46) into which the air flows without flowing through the first air passage or the second air passage, and the waste heat air passage (47) through which the air flowing through the third air passage flows out of the casing without flowing through the first air passage or the second air passage. A first peltier device and a second peltier device are provided, and the heat absorbing side of the first peltier device and the second peltier device are located in the second air passage. The heat generating side of the first peltier device is located in the first air passage and joined with a first heat radiation member (22) configured to radiate the heat of the heat generating side to the air in the first air passage. The heat generating side of the second peltier device is located in the waste heat air passage and joined with a second heat radiation member (22) configured to radiate the heat of the heat generating side to the air in the waste heat air passage.

According to this, the heat absorption in the second air passage is sufficiently performed by the heat absorbing side of the first peltier device and the heat absorbing side of the second peltier device. In particular, the temperature of the heat absorbing side of the second peltier device is well decreased due to the heat radiation from the heat radiation member located in the waste heat air passage. Accordingly, the moisture can be well adsorbed by the adsorbent.

According to an eleventh aspect, the cooling member (23) configured to cool the air in the second air passage, and the cooling member is fixed to the heat absorbing side of the first peltier device and the heat absorbing side of the second peltier device. According to this, the air in the second air passage can be effectively cooled.

According to a twelfth aspect, a part of the heat radiation member protrudes to an outside of the casing. According to this, the part of the heat radiation member can be in contact with an object outside the casing, and the heat of the heat generating side of the peltier device can be radiated by transferring the heat of the heat radiation member to the object. The object outside the casing may include an outside air.

What is claimed is:

1. A humidifying device comprising:
a casing that defines
a first air passage that guides air to an adsorbent module accommodation portion accommodating an adsorbent module including an adsorbent, and
a second air passage through which the air flowing out of the adsorbent module accommodation portion flows, and
a peltier device that has
a heat absorbing side absorbing heat according to an electric current flowing in a junction of different metals,
a heat generating side generating heat due to heat transfer from the heat absorbing side; and
a heat radiation member fixed to the heat generating side, wherein
the radiation member is configured to radiate the heat of the heat generating side to the air in the first air passage,
the peltier device is housed in the casing such that the heat generating side is located in the first air passage and the heat absorbing side is located in the second air passage, and
the casing defines a waste heat air passage through which a part of the air passing through the heat radiation member flows out of the casing without flowing through the adsorbent module accommodation portion or the second air passage.

2. The humidifying device according to claim 1, wherein
the casing includes a partition wall that partitions a space inside the casing into a first space and a second space,
the partition wall defines a turn portion through which the first space and the second space communicate with each other,
the peltier device is provided in the partition wall,
the heat generating side is located in the first space partitioned by the partition wall, and
the heat absorbing side is located in the second space partitioned by the partition wall.

3. The humidifying device according to claim 1, wherein
a part of the heat radiation member protrudes to an outside of the casing.

4. The humidifying device according to claim 3, the humidifying device being mounted on a vehicle, wherein
the part of the heat radiation member protruding to the outside of the casing is in contact with a part of the vehicle.

5. The humidifying device according to claim 3, the humidifying device being mounted on a vehicle, wherein
the part of the heat radiation member protruding to the outside of the casing is in contact with a component that is cooled by a blower for air-conditioning of the vehicle.

6. A humidifying device comprising:
a casing that defines
a first air passage that guides air to an adsorbent module accommodation portion accommodating an adsorbent module including an adsorbent, and
a second air passage through which the air flowing out of the adsorbent module accommodation portion flows, and
a peltier device that has
a heat absorbing side absorbing heat according to an electric current flowing in a junction of different metals, and
a heat generating side generating heat due to heat transfer from the heat absorbing side, wherein
the peltier device is housed in the casing such that the heat generating side is located in the first air passage and the heat absorbing side is located in the second air passage,
the casing defines
a third air passage into which the air flows without flowing through the first air passage or the second air passage, and
a waste heat air passage through which the air flowing through the third air passage flows out of the casing without flowing through the first air passage or the second air passage,
the peltier device includes a first peltier device and a second peltier device each of which includes the heat absorbing side and the heat generating side,
the heat absorbing side of the first peltier device and the heat absorbing side of the second peltier device are located in the second air passage,
the heat generating side of the first peltier device is located in the first air passage and joined with a first heat radiation member configured to radiate the heat of the heat generating side to the air in the first air passage, and
the heat generating side of the second peltier device is located in the waste heat air passage and joined with a second heat radiation member configured to radiate the heat of the heat generating side to the air in the waste heat air passage.

7. The humidifying device according to claim 6, wherein
the casing includes a partition wall that partitions a space inside the casing into a first space and a second space,
the partition wall defines a turn portion through which the first space and the second space communicate with each other,
the peltier device is provided in the partition wall,
the heat generating side is located in the first space partitioned by the partition wall, and
the heat absorbing side is located in the second space partitioned by the partition wall.

8. The humidifying device according to claim 6, further comprising:
a cooling member configured to cool the air in the second air passage, wherein
the cooling member is fixed to the heat absorbing side of the first peltier device and the heat absorbing side of the second peltier device.

9. The humidifying device according to claim 6, wherein
a part of the heat radiation member protrudes to an outside of the casing.
